(19) United States
(12) Patent Application Publication
(10) Pub. No.: US 2008/0140734 A1
(43) Pub. Date: Jun. 12, 2008

(54) METHOD FOR IDENTIFYING LOGICAL DATA DISCREPANCIES BETWEEN DATABASE REPLICAS IN A DATABASE CLUSTER

(76) Inventor: Robert Edward Wagner, North York (CA)

Correspondence Address: DIMOCK STRATTON LLP, 20 QUEEN STREET WEST SUITE 3202, BOX 102, TORONTO, ON, M5H 3R3, omitted

(21) Appl. No.: 11/952,460

(22) Filed: Dec. 7, 2007

Related U.S. Application Data
(60) Provisional application No. 60/868,935, filed on Dec. 7, 2006.

(51) Int. Cl. G06F 17/30

(52) U.S. Cl. 707/202; 707/E17.007

(57) ABSTRACT

A method and system for monitoring the consistency of replicated databases in a shared-nothing database cluster architecture is presented. The method involves the continuous monitoring of the database transaction logs that are maintained by the autonomous database managers that manage the individual database replicas in the cluster. In the event that data discrepancies are detected via the comparison of the transaction logs of the individual database replicas, remedial action is carried out according to configured rules in the main cluster controller. Additionally, if the database management system running within each node of the cluster possesses a database history file that records key events pertaining to a database replica, such as the occurrence of non-logged bulk loads of table data, or the modification of tables, a method can be instituted for the monitoring of the history files for discrepancies between the database replicas.

### REFERENCE TO PRIOR APPLICATIONS

This application claims priority from U.S. Application No. 60/868,935, filed Dec. 7, 2006.

### FIELD OF THE INVENTION

This invention relates to databases. In particular, this invention relates to identifying discrepancies between databases.

### BACKGROUND OF THE INVENTION

Strategies have been developed for improving the performance of databases with respect to query (i.e. read only) and transactional (i.e. data update/insertion/deletion) performance in databases.

One strategy is to employ a multi-node cluster of shared-nothing database servers that are each running standard, off-the-shelf, relational database management system software. Software implementing relational database management system (RDBMS) software is available from a number of sources, including from Oracle Corporation, International Business Machine Corporation, Microsoft Corporation, Sybase Inc. and MySQL AB.

Typically, RDBMS software generates a transaction log of transactions on the database. The transaction log is generally used for database backup and recover operations.

A ‘shared-nothing’ architecture means that each database node in the cluster shares a minimum of resources with other database nodes. In a shared-nothing architecture, the failure of a database node has little or no effect on the other database nodes in the system.

Generally, the cluster of database nodes is coordinated by a separate cluster controller that resides in an architectural tier between the database nodes and the client computers that are accessing the database servers. In this architecture, the cluster controller virtualizes the cluster of standalone database servers such that they appear as a single database server to the client computers. This strategy generally works very well for improving query performance over a single implementation of the database system, but typically offers little benefits for improving transactional performance. The system may be scaled up to handle larger query loads by adding additional database nodes to the cluster. The database nodes may also be separated physically to improve disaster recovery of the system.

A shared-nothing database cluster is typically used with repositories of data that are subject to frequent query activity and occasional transactional activity (insertions, modifications, deletions). As an example, an electronic commerce website may maintain a database that contains data on the available items offered for sale and which responds to inquires regarding availability and pricing. Typically the data contained in the database would be updated relatively infrequently compared to the rate at which the data is queried by customers.

### BRIEF DESCRIPTION OF THE DRAWINGS

In drawings which illustrate by way of example only a preferred embodiment of the invention,

FIG. 1 is a schematic representation of an equal-peer architecture embodiment of the invention.

FIG. 2 is a schematic representation of a master/slave architecture embodiment of the invention.

FIG. 3 is a schematic representation of a master/slave architecture embodiment of the invention with the master node operating as the cluster controller.

### DETAILED DESCRIPTION OF THE INVENTION

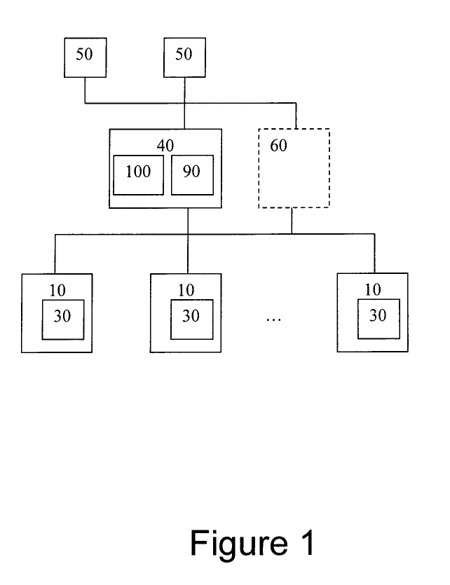

In an equal-peer architecture, the multi-node cluster 1 of shared-nothing database nodes 10 comprises a number of architectural elements as shown in FIG. 1 including a set of two or more database nodes 10. Each of the database nodes possesses a separate collection of relational or otherwise structured data connected by a communication network 20. Each node may be running standard, off-the-shelf, RDBMS software and each one of these nodes 10 is self-contained, with each node running its own instance of RDBMS software, and independently managing its own databases 30 within the cluster. Preferably, each database node 10 shares minimal resources with the other database nodes 10 in the cluster 1. The nodes may be on separate physical hardware or separate virtual nodes on a larger computer.

A cluster controller 40 manages the interactions that occur between the database nodes 10 in the cluster and the various database client nodes 50 that need to read data from the cluster 1, and that need to modify data residing in the cluster 1. To improve the reliability of the system, a standby cluster controller 60 may be employed to automatically take over from the primary cluster controller 40 in the case that the primary cluster controller fails for any reason, including hardware or software failure.

The communication network 20 allows the cluster controller 40 to communicate with the database nodes 10 in the cluster 1, and that allows client nodes 50 to access the virtualized database presented by the cluster controller 40. An Ethernet network may be used for such a communication network.

Each database node 10 in the cluster maintains a complete, separate database 30 that is expected to be logically identical to that maintained by the other nodes in the cluster 1 (assuming that all database nodes 10 in the cluster 1 have had the same set of transactions applied by the cluster controller 40).

Therefore, it is appropriate to state that each database 30 in the cluster is replicated by a factor that is equal to the number of database nodes 10 in the cluster 1. In other words, the same data is represented in each of the databases contained within each of the database nodes 10. All the databases 30 that are part of the cluster configuration are termed replicated databases and an individual instance of each replicated database 30 on each database node 10 is termed a database replica.

Normally, there is no direct interaction between the database nodes 10 in the cluster 1 and the client nodes 50 that need to access the data that resides in the database nodes 10. Instead, such interactions between the client nodes 50 and the database nodes 10 are mediated by the cluster controller 40. The details of the architecture may not be known to the client nodes 50 and the cluster controller 40 effectively allows the client nodes 50 to interface with the multiple database nodes 10 as a single virtual database server.

When a client node 50 wishes to query the virtualized database, the query is submitted to the cluster controller 40. The cluster controller 40 submits this request to only one of the database nodes 10 in the cluster 1. Typically, the controller uses a load-balancing algorithm to select a single database node to execute the query from among the nodes that are known to be most transactionally up-to-date with respect to the other nodes in the cluster. The node 10 that is selected by the cluster controller 40 may be selected on the basis of optimal response time to the query.

When a client node wishes to apply a transaction to a database, such as inserting data, updating existing data, or deleting data from the virtualized database, the transaction is submitted to the cluster controller 40. The cluster controller 40 passes this request on to all of the database nodes 10 in the cluster 1 for execution. The same transaction is performed on all of the instances of the database 30 contained in each of the database nodes 10. The intent of this parallel update process is to keep the database replicas 30 in the cluster as close to identical as possible over time.

When the cluster controller 40 applies a transaction to all of the database nodes 10 in the cluster 1, the controller 40 monitors the outcome of the transaction from each database node 10. In general, each database node 10 will return a result to the cluster controller 40 consisting of a count of the number of table rows affected by the transaction and any error/warning status codes that apply to the transaction. Thus, if all database nodes in the cluster return the same row count for a particular transaction, the cluster controller typically assumes that all database replicas have been identically updated by the transaction.

Typically, the cluster controller 40 is responsible for keeping track of the transactional state of each database replica in each database node 10 such as which transactions have been initiated, which transactions have been completed, and the final result of each transaction. Based on the transactional state of each database node 10, the cluster controller 40 can determine which database nodes 10 are most up to date, and which are therefore candidates for handling a query when such a request is received from a client node 50.

As an example, the Java Database Connectivity (JDBC™) 3.0 Specification (Dec. 1, 2001) may be used as the protocol between the cluster controller 40 and the database nodes 10. This specification indicates that when the execute method is used to run a query or a transaction, the method returns true if the first result is a ResultSet object (i.e. for a query) and false if the first result is an update count (i.e. for a transaction). Then, additional methods must be called to retrieve the ResultSet object (e.g. the method getResultSet), or to retrieve the update count (e.g. the method getUpdateCount), or to retrieve additional results, if any, from the database node 10.

### Master/Slave Architecture

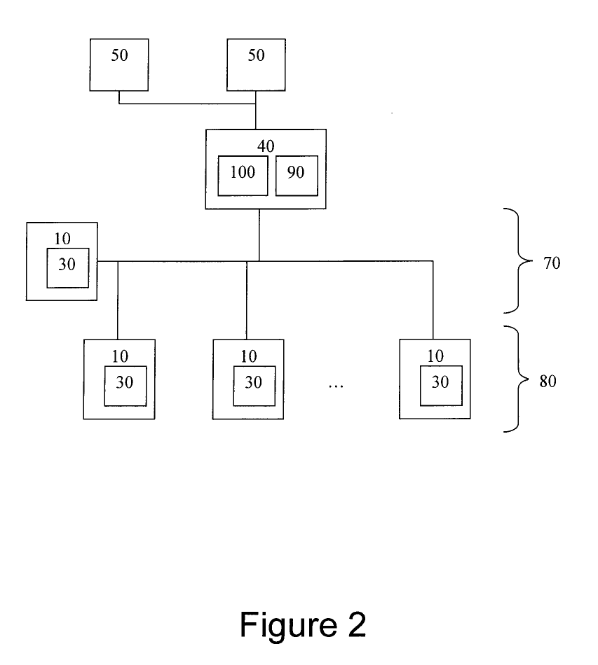

In a master/slave topology as shown in FIG. 2, one of the database nodes 10 is designated as the master database node 70. As in the equal-peer topology described earlier, the cluster 1 contains two or more database nodes 10 running standard, off-the-shelf, relational database management system (RDBMS) software. Each one of these nodes is self contained, with each node 10 running its own instance of RDBMS software, and independently managing its own databases 30 within the cluster.

The master database node 70 is responsible for handling transaction requests from client nodes 50, and propagating all resulting data content changes to the other database nodes 10 in the cluster, termed slave database nodes 80, each of which host one or more slave database replicas. The master database node 70 hosts one or more master databases. All data updates are applied to the slave database nodes 80 (via the master node 70) only after the data updates have been applied to the master database node 70.

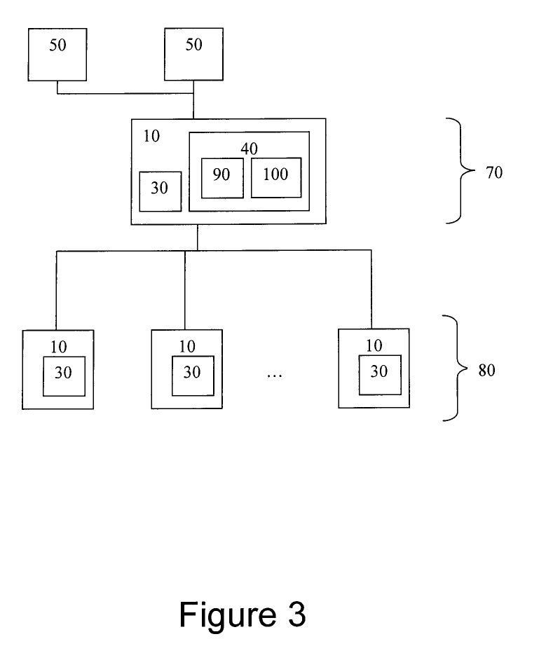

The cluster 1 contains a cluster controller 40 that manages the interactions that occur between the database nodes 10 in the cluster 1 and the various client nodes 50 that read data from the cluster 1, and that modify data residing in the cluster. The functions of the cluster controller 40 may either be performed by a separate node that does not host any database replicas, as shown in FIG. 2, or by the master database node 70 itself in which case a cluster controller 40 would be contained within the master database node 70, as shown in FIG. 3.

Each database node 10 in the cluster maintains a complete set of database data 30 that is expected to be logically identical to that maintained by the other nodes in the cluster 1, assuming that all slave database nodes 80 in the cluster 1 have received and applied all the replicated data changes from the master database node 70.

Therefore, it is appropriate to state that each database 30 in the cluster is replicated by a factor that is equal to the number of database nodes 10 in the cluster 1. In other words, the same data is represented in each of the databases contained within each of the database nodes 10.

As in the equal-peer topology, there is normally no direct interaction between the database nodes 10 in the cluster 1 and the client nodes 50 that need to access the data that resides in the database nodes 10. Instead, such interactions between the client nodes 50 and the database nodes 10 are mediated by the cluster controller 40, or by the master database node 70 if the function of the cluster controller 40 is performed by the master database node 70.

When a client node 50 wishes to query the virtualized database, the query is submitted to the cluster controller 40. The cluster controller 40 submits this request to only one of the database nodes 10 in the cluster 1. Typically, the controller uses a load-balancing algorithm to select a single database node to execute the query from among the nodes that are known to be most transactionally up-to-date with respect to the other nodes in the cluster. By definition, the master database node 70 is always the most transactionally up to date, but slave database nodes 80 may be equally as up to date and be selected by the cluster controller 40 for receiving a query.

When a client node wishes to apply a transaction to a database, such as inserting data, updating existing data, or deleting data from the virtualized database, the transaction is submitted to the cluster controller 40. The cluster controller 40 passes this request on to the master database node 70. The master database node then propagates any changes to the database to the slave database nodes 80. In this way, the slave databases are maintained closely synchronized with the master database node 80.

The controller 40 typically monitors the outcome of a transaction from each database node 10. In general, each database node 10 will return a result to the cluster controller 40 consisting of a count of the number of table rows affected by the transaction and any error/warning status codes that apply to the transaction. Thus, if all database nodes in the cluster return the same row count for a particular transaction, the cluster controller typically assumes that all database replicas have been identically updated by the transaction. By monitoring the transactional state of each slave database node 80, the cluster controller can select which database node 10 should execute a query when a query is received from a client node 50.

### Transaction Log Monitoring

Transactions or the loading of data that is applied to a particular database node 10 without involving the cluster controller 40 can lead to data discrepancies between the database replicas 30 in the cluster 1. There is also the potential that implementation faults in the replication algorithm of the cluster controller 40 or master database node 70 could lead to unanticipated data discrepancies between the database replicas. Even a single row added to a database table that is not replicated across the other database nodes 10 could have serious consequences to the accuracy and consistency of both queries and transactions that are handled by the cluster 1. Logical data differences between database replicas may arise from hardware or software failures, communication interruptions between the nodes 10 in the cluster 1, or failure modes involving one or more of the nodes 10 in the cluster 1.

A transaction log is generally maintained by the RDBMS database software that runs within each database node 10. The transaction log is generally exclusively written to by the RDBMS database software and is distinct from any logs that are maintained by the cluster controller. The transaction log records the exact details of each logged update or modification of data within the associated database. The transaction log completely specifies all logged data changes that have been applied to the associated database since the transaction log was last initialized or re-initialized.

In the preferred embodiment, a monitoring subsystem 90 operates on the cluster controller 40 and monitors the detailed content of the database transaction log of each database replica 30 within each database node 10 of the cluster 1.

When the cluster controller 40 sends a transaction request to a particular database node 10, the monitoring subsystem 90 notes the contents of the database node's transaction log. After the requested transaction has been completed for a particular database node 10, the monitoring subsystem 90 again notes the contents of the database node's transaction log and determines the details of the database changes as a result of the transaction.

All the incremental database transaction log changes obtained by the monitoring subsystem 90 are stored at the cluster controller 40 with transaction identification information provided by the cluster controller 40.

After multiple database replicas 30 have completed the same transaction, as directed by the cluster controller 40, the cluster controller examines the incremental changes of each database transaction log as identified by the monitoring subsystem 90. In general, the transaction log changes are expected to be identical for each database node 10 that completes the same transaction, so if any discrepancies are identified, remedial actions may be initiated by the cluster controller 40.

In an equal-peer architecture, one such remedial action may be to take a particular database node 10 off-line within the cluster if the transaction log monitoring results associated with the particular database replica are different from the common result yielded by the other replicas of the database running within other database nodes 10 of the cluster 1. After a database replica is taken off-line in the cluster, the cluster controller 40 no longer sends query or transaction requests to the off-line replica, but the remaining on-line replicas of the same database nodes 10 in the cluster continue to service query and transaction requests from the cluster controller 40.

In a master/slave architecture, a remedial action may be to take a particular slave database node 80 off-line within the cluster if the transaction log monitoring results associated with the particular database replica 30 are different from the results associated with the master database node 70 of the cluster 1. After a database replica is taken off-line in the cluster, the cluster controller 40 no longer sends query or transaction requests to the off-line replica, but the remaining on-line replicas of the same database nodes 10 in the cluster continue to service query and transaction requests from the cluster controller 40.

Another remedial action may be to send a notification event to an operational console of the cluster system to alert a human operator, or possibly to other enterprise monitoring systems in communication with the cluster 1.

If the discrepancy is associated with a table field that represents a database-generated timestamp, another remedial action may be to synchronize the value of the timestamp between the database nodes 10. Synchronization may be done by selecting the earliest timestamp from those in other database nodes 10.

If the monitoring subsystem 90 identifies a transaction log change that does not correlate with any transaction that is orchestrated by the cluster controller 40, this is an indication that a database transaction has been applied to the database replica without involvement of the cluster controller 40. Remedial action may be taken by the cluster controller, including taking the database node with the unexpected transaction off-line or sending a notification event to the operational console or other monitoring systems.

It is understood that the cluster controller 40 and monitoring subsystem 90 can be configured such that certain types of cross database discrepancies detected by the cluster controller 40 are ignored. For example, it may be acceptable to ignore discrepancies that occur in certain database tables; likewise, discrepancies in certain table columns may be considered to be normal and acceptable, or to have no significant impact on the overall data integrity of the database cluster. The configuration of which discrepancies are ignored may be altered by an operator and persist after restarting a database node. An example of a discrepancy that may be ignored is a timestamp representing when a database was modified for auditing purposes. If such a timestamp is not used directly or indirectly by other internal functions of the database, or by external applications that use the database, it may be acceptable that the timestamps be different as between the database replicas 30. A temporary table used for recording intermediate results is another example of a discrepancy that may be ignored if the contents of the temporary table are not used after the final outcome is derived. Such a temporary table may not be monitored for discrepancies.

Any discrepancies detected by the cluster controller 40 and any remedial action taken may be logged to a persistent alerts log file. The alerts log file may be subject to analysis to understand what discrepancies arose in order to try to avoid discrepancies arising in the future.

The monitoring subsystem 90 may maintain a persistent state file to provide a record of the state of each transaction log at the time of the last shutdown of the cluster controller 40. When the cluster controller 40 is re-started, by comparing the state file that applies for each transaction log with the current contents of each transaction log, the monitoring subsystem 90 is able to determine if any databases have been modified while the cluster controller 40 was not available by processes that were not orchestrated by the cluster controller 40. Databases with inconsistencies may be taken off-line.

In one embodiment, the cluster controller 40 may communicate with the monitoring subsystem 90 regarding transactions. When the cluster controller 40 is ready to send a transaction request to a particular database node 10, it first checks if there are any other in-progress transactions for the particular database server 10. If there are no in-progress transactions, the cluster controller 40 alerts the monitoring subsystem 90 to note the current state of the transaction log for the particular database node 10. After the monitoring subsystem 90 determines the current state of the necessary transaction log, it sends a message to the cluster controller 40 that the state has been noted. The cluster controller 40 then dispatches the pending transaction request to the target database node 10. By this process, any further additions to the transaction log can be readily determined.

When a transaction is completed for the target database server 10, the cluster controller 40 checks if there are any other in-progress transactions for the particular database node 10. If not, the cluster controller 40 asks the monitoring subsystem 90 to re-examine the state of the transaction log for the database node 10, and to report back on the details of all data changes that have taken place since the state was earlier determined. After the monitoring subsystem 90 reports back to the cluster controller 40 on the detected data changes in the transaction log, the cluster controller 90 saves the data change details along with the list of transactions that were responsible for causing the detected data changes. The cluster controller 40 then continues with other pending query and transaction requests for the database node 10.

If there are in-progress transactions for the particular database node 10 when the transaction request is completed, the cluster controller 10 does not ask the monitoring subsystem to re-examine the state of the transaction log for the database node 10, since other transactions in progress may affect the transaction log. Instead, the cluster controller continues sending query and transaction requests to the database node.

After a set of two or more database nodes 10 have completed the same set of transactions, as managed by the cluster controller 40, and the cluster controller 40 has incremental data changes that apply for the common transactional state as reported by the monitoring system, the cluster controller can determine if the data content of the database replicas 30 are the same for the set of database nodes 10. If any discrepancies are identified, remedial actions can be initiated by the cluster controller 40.

If the monitoring subsystem 90 detects changes to a particular transaction log, and the monitoring subsystem 90 has not been notified by the cluster controller 40 that one or more transactions are in progress for the database node 10, this likely indicates that a database transaction has occurred, or is in progress, on the particular database node 10 without the involvement of the cluster controller 24. In this case, remedial actions can be initiated by the cluster controller 40.

For use with some database software, an embodiment of the invention includes using database triggers as an alternative to a transaction log to monitor activity of database nodes. In this alternative embodiment, table triggers are created and associated with each table in each database 30 that may be affected by transaction requests. Three triggers are preferably created. An insert trigger is invoked by the database software each time a new row or record is added to the table associated with the trigger. An update trigger is invoked each time the data content of a row or record is updated or modified in the table associated with the trigger. Two separate update triggers may be used in tandem, one to record the content of the updated record prior to the update, and one to record the content of the updated record after the update. A delete trigger is invoked each time a row or record is deleted from the table associated with the trigger. As a result of any of the triggers being invoked, a message is logged to the alternative log containing information about the change. The logged information may include the name and identifier of the database replica, a timestamp indicating the date and time of the data modification, the name of the affected table and the details on the data being added, deleted or modified in the table.

The alternative log for a database replica may be maintained as a persistent file at the database node 10 or kept as a table within the database associated with the database node 10.

In a further embodiment, the cluster controller may communicate directly with the RDBMS software running within the database nodes 10 to directly obtain information about what transactions have been completed and what tables and data have been modified as a result of a given transaction. For example, when a new data record is added, the cluster controller may obtain information on the name of the affected table and the exact details of all the data added to the affected table. When existing data is removed from the database as a result of the transaction, the name of the affected table and the details of all data removed from the affected table are obtained by the cluster controller. Similarly, when a database record is modified, the name of the affected table and details of the modified data in the affected table, including before and after values for all the fields in the record are made available to the cluster controller. For large data fields, checksums or size information may be used rather than the entire contents of the field. Under this embodiment, the transaction logs are not monitored and the information is obtained directly by the cluster controller 40 from the RDBMS software running within the database nodes by the cluster controller.

Direct access to the database nodes by the cluster controllers similarly may not account for data changes not managed by the cluster controller.

### Database History Files

In some database systems, a database history file logs details regarding actions that are performed against the associated database. These actions may include loading a table through a means that is not logged as a transaction, data is reorganized within a table, or a table is created, renamed or deleted.

If a particular database management system that is employed within a shared-nothing cluster does support the history file feature, then the history file can also be used to help monitor for structural or data content inconsistencies between database replicas in the shared-nothing database cluster architecture. In a preferred embodiment of the invention, a history file monitoring subsystem 100 monitors the history file for each database replica in each database node 10 in the cluster 1.

In the preferred embodiment, the history file monitoring subsystem 100 operates at the cluster controller 40 and monitors the contents of the database history file for each database replica 30 within each database node 10 of the cluster 1. For each change in the database history file, the history file monitoring subsystem 100 determines whether the change reflects data content changes or structural changes within the database replica 30. Note that structural database changes are considered to include the creation of new tables, the renaming of an existing table, and the deleting of an existing table.

If history file monitoring subsystem 100 detects a structural change for an on-line (active) database replica 30, it sends a notification message to cluster controller 40. Possible remedial actions that may be initiated by cluster controller 40 upon receipt of the notification message include:
a. maintaining the affected database replica as off-line until all other corresponding database replicas in the cluster have been similarly modified; or
b. sending a notification event to the operational console of the cluster system, and optionally to other enterprise monitoring systems.

If a database replica 30 is taken off-line by the cluster controller 40 in response to a structural change, as detected by the history file monitoring subsystem 100, a human operator would have the option of manually bringing the database replica back on-line within the database cluster.

If the history file monitoring subsystem 100 detects a structural change for an off-line (inactive) database replica, it preferably sends a notification message to the cluster controller 40. Possible remedial actions that may be initiated by the cluster controller 40 upon receipt of the notification message include:
a. taking the affected database replica off-line until all other corresponding database replicas in the cluster have been similarly modified; or
b. sending a notification event to the operational console of the cluster system, and possibly to other enterprise monitoring systems.

If the history file monitoring subsystem 100 detects a non-logged load of data into a particular table for an on-line (active) or off-line (inactive) database replica, it sends a notification message to the cluster controller 40. Possible remedial actions that may be initiated by the cluster controller upon receipt of the notification message include: a) taking the affected database replica off-line until all other corresponding database replicas in the cluster have been similarly modified, or b) sending a notification event to the operational console of the cluster system, and optionally to other enterprise monitoring systems. If the affected database is automatically taken off-line within the cluster, the cluster controller 40 may keep the database off-line until a row-by-row comparison of data in the affected table has been performed between the various database replicas in the cluster. An inter-database table comparison may be automatically triggered by a logical rule such as all database replicas 30 in the cluster 1 being subject to a similar non-logged load of table data within a particular time frame, or may be manually triggered at the discretion of a human operator.

It is understood that the history file monitoring subsystem 100 can be custom configured such that certain types of cross database discrepancies detected by the history file monitoring subsystem 100 are ignored. For example, it may be acceptable to ignore discrepancies that apply to certain database tables, since they are considered to have no significant impact on the overall data integrity of the database cluster. Which types of cross database discrepancies are ignored may be configurable and persisted between restarting of the database nodes and cluster.

If particular database software does not generate a suitable database history file for the purposes described above, an alternative technique may be available to the purposes of this invention. The cluster controller may monitor system tables within each of the database nodes 10. The system tables, depending on the specific implementation of the database software, generally maintain management information regarding the structure of tables within the database. By monitoring the system tables, the cluster controller or a monitoring subsystem may detect changes to data tables, triggers, stored procedures and other structural attributes of the database.

In a further alternative, triggers may be associated with the system tables of the database. The triggers may then be used to detect changes to the system tables that correspond to structural changes within the database. As described earlier in relation to the alternative transaction log, a similar alternative database history log can be produced by using triggers associated with the system tables of the database.

Various embodiments of the present invention having been thus described in detail by way of example, it will be apparent to those skilled in the art that variations and modifications may be made without departing from the invention. The invention includes all such variations and modifications.

I claim:

1. A system for monitoring data consistency comprising:
a plurality of database nodes each capable of operating independently, each containing at least one database;
a transaction log for recording each insertion, deletion or modification of data for each of the at least one databases in the database nodes;
a controller node in communication with the database nodes for receiving at least one database transaction request from at least one client node, the controller node sending all database transaction requests from at least one client nodes to all of the database nodes, and monitoring the results of each of the database transaction requests sent to the database nodes;
whereby the transaction logs of each of the database nodes which are determined by the controller node to have completed the same database transaction requests are compared to detect any inconsistency.

2. The system of claim 1 wherein upon detecting an inconsistency remedial action is taken.

3. The system of claim 2 wherein the remedial action comprises at least one of making at least one of the database nodes inactive and recording the inconsistency.

4. The system of claim 2 wherein the remedial action comprises alerting an operator of the inconsistency.

5. The system of claim 1 further comprising a standby controller node for replacing the controller node if the controller node is rendered inoperable.

6. The system of claim 2 wherein the inconsistencies upon which remedial action is taken is determined by the configuration of the system.

7. The system of claim 1 further comprising
at least one trigger associated with at least one of the databases in the database nodes triggered by content changes to the at least one of the databases;
where the transaction log for each of the at least one database in the database nodes is generated by the at least one trigger;

8. The system of claim 7 wherein the remedial action is at least one of making at least one database node inactive and recording the inconsistency.

9. The system of claim 7 wherein the remedial action comprises alerting an operator of the inconsistency.

10. The system of claim 7 further comprising a standby controller node for replacing the controller node if the controller node is rendered inoperable.

11. The system of claim 7 wherein the inconsistencies upon which remedial action is taken is determined by the configuration of the system.

12. A system for maintaining data consistency comprising:
a plurality of slave database nodes each capable of operating independently, each containing at least one database;
a master database node capable of operating independently, containing at least one database such that all changes to the at least one database are replicated to all of the at least one databases contained in the slave database nodes;
a transaction log for recording each insertion, deletion or modification of data for each of the at least one databases in the slave database nodes and the master database node;
a controller node in communication with the slave database nodes and the master database node for receiving at least one database transaction request from at least one client node, the controller node sending all database transaction requests from the at least one client node to the master database node, the master database node replicating all changes to all of the at least one slave database nodes, the controller node monitoring the results of each of the database transaction requests sent to the slave database nodes;
whereby the transaction logs of the master database node and each of the slave database nodes which are determined by the controller node to have completed the same database transaction request are compared to detect any inconsistency.

13. A method of monitoring consistency between a plurality of database nodes each containing at least one database, comprising the steps of:
receiving at least one database transaction request from at least one client node;
sending the at least one database transaction request from the at least one client node to all of the database nodes;
recording each insertion, deletion or modification of data for each of the least one databases in the database nodes in a transaction log;
monitoring the results of each of the database transaction requests sent to the database nodes; and
comparing the transaction logs of each of the database nodes which are determined to have completed the same database transaction requests

14. The method of claim 13 comprising, upon detecting an inconsistency, the step of taking remedial action.

15. The method of claim 14 wherein the remedial action comprises at least one of the steps of making at least one of the database nodes inactive and recording the inconsistency.

16. The method of claim 14 wherein the remedial action comprises the step of alerting an operator of the inconsistency.

17. A system for monitoring data consistency comprising:
a plurality of database nodes each capable of operating independently, each containing at least one database;
a controller node in communication with the database nodes for receiving at least one database transaction requests from at least one client node, the controller node sending all database transaction requests from at least one client nodes to all of the database nodes, and monitoring the results of each of the database transaction requests sent to the database nodes;
whereby the data changes induced by each of the database transaction requests at each of the database nodes are compared to detect any inconsistency.

18. The system of claim 17 wherein upon detecting an inconsistency remedial action taken.

19. The system of claim 18 wherein the remedial action comprises at least one of making at least one of the database nodes inactive, and recording the inconsistency.

20. The system of claim 18 wherein the remedial action comprises alerting an operator of the inconsistency.

21. A method of maintaining consistency between a plurality of database nodes each containing at least one database comprising the steps of:
receiving at least one database transaction request from at least one client node;
sending the at least one database transaction request from the at least one client node to all of the database nodes;
monitoring the results of each of the database transaction requests sent to the database nodes and obtaining information on all data changes induced by the database transaction request; and
comparing the data changes induced at each of the database nodes which are determined to have completed the same database transaction request.

22. The method of claim 21 comprising, upon detecting an inconsistency, the step of taking remedial action.

23. The method of claim 22 wherein the remedial action comprises at least one of the step of making at least one of the database nodes inactive and recording the inconsistency.

24. The method of claim 22 wherein the remedial action comprises the step of alerting an operator of the inconsistency.
